(19) United States
(12) Patent Application Publication
(10) Pub. No.: US 2026/0176099 A1
(43) Pub. Date: Jun. 25, 2026

(54) FILAMENT WINDING DEVICE

(71) Applicant: HONDA MOTOR CO., LTD., TOKYO (JP)

(72) Inventors: Masanori HORI, WAKO-SHI (JP); Yuki NISHITARUMIZU, WAKO-SHI (JP); Yoshikazu SHINNABE, WAKO-SHI (JP)

(21) Appl. No.: 19/419,315

(22) Filed: Dec. 15, 2025

(30) Foreign Application Priority Data
Dec. 19, 2024 (JP) 2024-223884

(51) Int. Cl. B65H 54/28; B65H 54/24

(52) U.S. Cl. CPC B65H 54/2836; B65H 54/24

(57) ABSTRACT

The filament winding device includes a fiber feeding head for feeding a fiber bundle to a workpiece. The fiber feeding head includes a spreader roller and a damper mechanism. The fiber bundle is wound around the side surface of the spreader roller. The damper mechanism moves the spreader roller in a direction that shortens the path length of the fiber bundle as the tension of the fiber bundle increases. The damper mechanism moves the spreader roller in a direction that increases the path length of the fiber bundle as the tension of the fiber bundle decreases.

### CROSS-REFERENCE TO RELATED APPLICATIONS

This application is based upon and claims the benefit of priority from Japanese Patent Application No. 2024-223884 filed on Dec. 19, 2024, the contents of which are incorporated herein by reference.

### BACKGROUND OF THE INVENTION

### Field of the Invention

The present disclosure relates to a filament winding device.

### Description of the Related Art

The filament winding device is a device that winds a fiber bundle, which is a bundle of a plurality of fibers, around a workpiece. Specifically, a delivery head supplies the fiber bundle to the workpiece while moving relative to the workpiece along the axial direction of the workpiece. The fiber bundle is wound around the workpiece by hoop winding or helical winding, thereby forming a reinforcing layer. The reinforcing layer imparts strength to the workpiece.

In the case where the fiber bundle is helically wound around the workpiece, the delivery head decelerates when reaching an axial end portion of the workpiece, changes the moving direction, and then accelerates when moving toward the axial center portion of the workpiece. Due to such a change in speed, the path length of the fiber bundle changes, and the tension varies. When the tension becomes excessively small due to the variation, there is a concern that the fiber bundle is not appropriately wound around the workpiece at the axial end portion thereof.

The present applicant has proposed a filament winding device capable of imparting sufficient strength to both the axial center and axial end portions of a workpiece in JP 2024-093045 A.

### SUMMARY OF THE INVENTION

There is a demand for a filament winding device capable of imparting sufficient strength to both of an axial center portion and axial end portions of a workpiece with a simple configuration.

The present disclosure has the object of solving the aforementioned problem.

An aspect of the present disclosure is to provide a filament winding device configured to wind around a workpiece a fiber bundle formed of a plurality of fibers, the filament winding device comprising: a delivery head configured to move relative to the workpiece; and a fiber feeding head, with which the delivery head is provided, the fiber feeding head being rotatable relative to the delivery head, wherein the fiber feeding head includes: a spreader roller that has a side surface around which the fiber bundle is wound, the spreader roller being configured to widen the fiber bundle on the side surface; and a damper mechanism supporting the spreader roller, the damper mechanism being configured to suppress variation in tension of the fiber bundle supplied to the workpiece, wherein the damper mechanism moves the spreader roller in a direction that shortens a path length of the fiber bundle as the tension of the fiber bundle increases, and move the spreader roller in a direction that increases the path length of the fiber bundle as the tension of the fiber bundle decreases.

According to the present disclosure, the fiber bundle can be appropriately wound around the workpiece. Therefore, sufficient strength is imparted to the workpiece.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic configuration diagram of a filament winding device according to an embodiment of the present invention;

FIG. 2 is a schematic side view of a liner as a workpiece as viewed from a direction orthogonal to an axial direction;

FIG. 3 is a schematic perspective view of a fiber feeding head; and

FIGS. 4A, 4B and 4C are schematic front views of a damper mechanism, illustrating situations in which an arm member is rotationally moved, and a spreader roller is shifted.

### DETAILED DESCRIPTION OF THE INVENTION

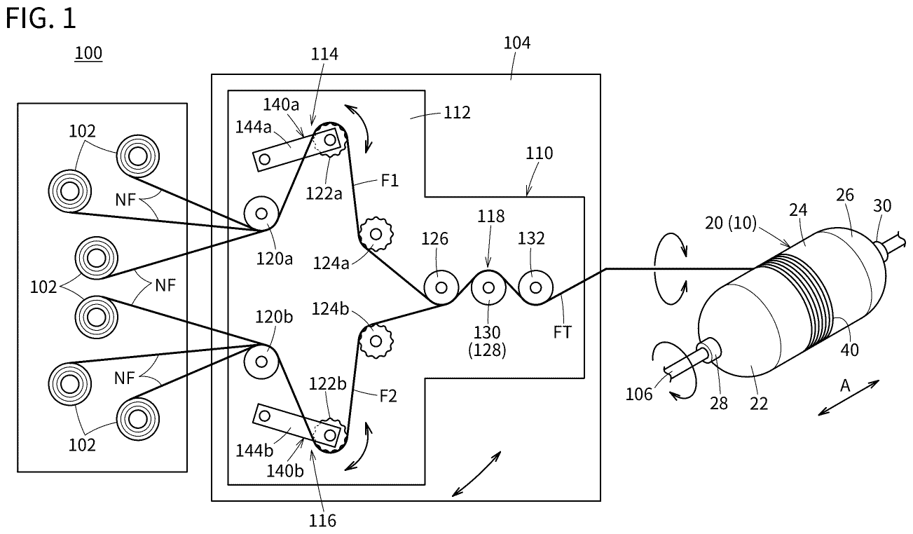

Hereinafter, a filament winding device may be abbreviated as “FW device”. In the present embodiment, an example in which a workpiece 10 shown in FIG. 1 is a liner 20 made of resin or metal will be described. In this case, the product is a high-pressure tank. However, the workpiece 10 is not limited to the liner 20, and the product is not limited to the high-pressure tank.

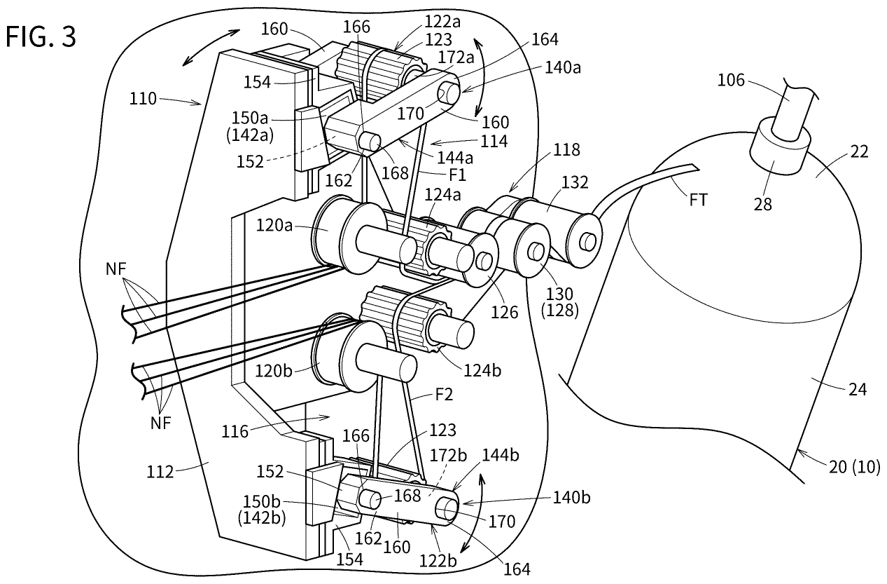

Further, in the following description, in order to facilitate distinction between a spreader roller 122a and another spreader roller 122b illustrated in FIG. 3, the spreader roller 122a is denoted as a “first spreader roller 122a”, and the other spreader roller 122b is denoted as a “second spreader roller 122b”. Similarly, in order to facilitate the distinction between the damper mechanism 140a and the other damper mechanism 140b, the damper mechanism 140a is denoted as a “first damper mechanism 140a”, and the other damper mechanism 140b is denoted as a “second damper mechanism 140b”. In order to facilitate the distinction between the fiber bundle F1 and the other fiber bundle F2, the fiber bundle F1 is referred to as a “first fiber bundle F1”, and the other fiber bundle F2 is referred to as a “second fiber bundle F2”.

FIG. 1 is a schematic configuration diagram of an FW device 100 according to the present embodiment. The FW device 100 winds, around the liner 20 as the workpiece 10, a belt-shaped bundle FT, which is a merged body of the first fiber bundle F1 (fiber bundle) and the second fiber bundle F2 (another fiber bundle). As a result, a reinforcing layer 40 is formed on an outer surface of the liner 20, and a high-pressure tank is obtained as a product. In FIG. 1, the feeding direction of the belt-shaped bundle FT and the posture of the liner 20 do not necessarily coincide with the feeding direction of the belt-shaped bundle FT and the posture of the liner 20 of the FW device 100 in practical use, respectively.

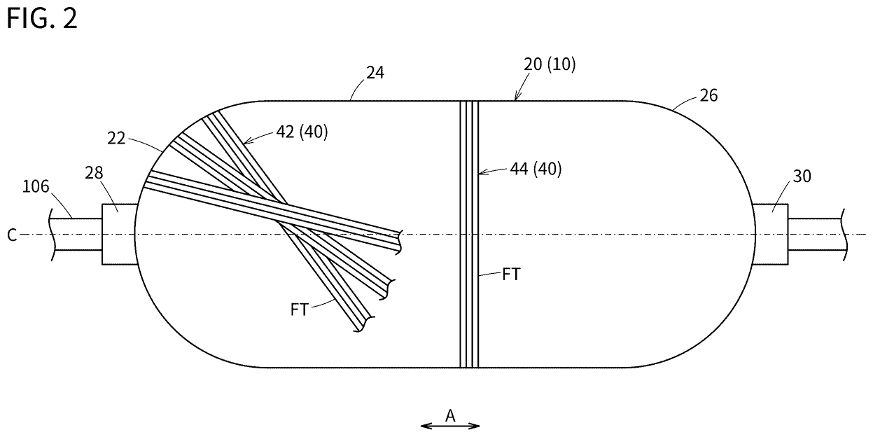

The liner 20 will be schematically described with reference to FIG. 2. The liner 20 includes a cylindrical portion 24, a first dome portion 22 continuous with one axial end of the cylindrical portion 24, and a second dome portion 26 continuous with the other axial end of the cylindrical portion 24. The axial direction of the liner 20 is the arrow A direction. The first dome portion 22 is equipped with a first cap 28 and the second dome portion 26 is equipped with a second cap 30. The liner 20 is supported by a support shaft 106 in a liner support portion (not shown). The support shaft 106 is located on a central axis C that passes through the center of the diameter of the cylindrical portion 24 and extends along the axial direction of the liner 20.

In the liner support portion, the liner 20 is rotatable integrally with the support shaft 106. The liner 20 rotates around the support shaft 106 (or the central axis C).

The FW device 100 forms a helical layer 42 on the first dome portion 22, the cylindrical portion 24, and the second dome portion 26 by helical winding. The FW device 100 forms a hoop layer 44 on the cylindrical portion 24 by hoop winding. Therefore, the helical layer 42 and the hoop layer 44 are layered in random order on the cylindrical portion 24. As described above, the reinforcing layer 40 includes the helical layer 42 and the hoop layer 44.

Next, a configuration of the FW device 100 will be schematically described with reference to FIG. 1. The FW device 100 includes a plurality of bobbins 102, a delivery head 104, and a fiber feeding head 110.

Each of the plurality of bobbins 102 is a supply source of a thin fiber bundle NF. The thin fiber bundle NF wound around each bobbin 102 is reeled out and moves toward the fiber feeding head 110. The thin fiber bundle NF is a bundle of a plurality of fibers. However, the fiber width of the thin fiber bundle NF is smaller than the fiber width of the first fiber bundle F1 and the fiber width of the second fiber bundle F2. An example of the thin fiber bundle NF is a bundle of a plurality of carbon fibers impregnated with resin.

The delivery head 104 is capable of moving relative to the liner 20. In the present embodiment, an example is described in which the liner 20 is supported by the support shaft 106 of the unillustrated liner support portion, and the delivery head 104 moves along the axial direction (A direction) of the liner 20.

The delivery head 104 is equipped with the fiber feeding head 110. Therefore, the fiber feeding head 110 is movable integrally with the delivery head 104 along the axial direction of the liner 20. The fiber feeding head 110 is rotatably supported by the delivery head 104 via a rotation shaft (not shown). As the rotation shaft rotates relative to the delivery head 104, the fiber feeding head 110 rotates relative to the delivery head 104.

Next, the configuration of the fiber feeding head 110 will be described in detail. As shown in FIG. 3, the fiber feeding head 110 has a base 112. With a plurality of rollers of the base 112, a first fiber bundle F1 (fiber bundle) is formed from the plurality of thin fiber bundles NF, and a second fiber bundle F2 (another fiber bundle) is formed from other plurality of thin fiber bundles NF. Further, one belt-shaped bundle FT is formed from the first fiber bundle F1 and the second fiber bundle F2. The belt-shaped bundle FT is supplied to the liner 20. Descriptions thereof will be made later.

The fiber feeding head 110 has a first conveyance path 114 for transporting the first fiber bundle F1, a second conveyance path 116 for transporting the second fiber bundle F2, and a third conveyance path 118 for transporting the belt-shaped bundle FT. In the first conveyance path 114, a first collecting roller 120a, a first spreader roller 122a (spreader roller), and a first consolidating roller 124a are arranged from upstream to downstream in the moving direction of the first fiber bundle F1. In the second conveyance path 116, a second collecting roller 120b, a second spreader roller 122b (another spreader roller), and a second consolidating roller 124b are arranged from upstream to downstream in the moving direction of the second fiber bundle F2. The first collecting roller 120a and the second collecting roller 120b are paired. Similarly, the first spreader roller 122a and the second spreader roller 122b are paired, and the first consolidating roller 124a and the second consolidating roller 124b are paired.

In the third conveyance path 118, an upstream guide roller 126, a detection roller 130 as a tension detector 128, and a downstream guide roller 132 (guide roller) are arranged. The upstream guide roller 126 is disposed downstream of the first consolidating roller 124a and the second consolidating roller 124b. The detection roller 130 is disposed downstream of the upstream guide roller 126, and the downstream guide roller 132 is disposed downstream of the detection roller 130. The downstream guide roller 132 is a roller located on the most downstream side among all the rollers provided in the fiber feeding head 110.

In the illustrated example, the first collecting roller 120a collects the thin fiber bundles NF supplied from three of the plurality of bobbins 102 to form one first fiber bundle F1. Similarly, the second collecting roller 120b collects the thin fiber bundles NF supplied from other three of the plurality of bobbins 102 to form one second fiber bundle F2. However, the number of thin fiber bundles NF collected by the first collecting roller 120a and the second collecting roller 120b may be other than three. Further, the number of thin fiber bundles NF collected by the first collecting roller 120a may be different from the number of thin fiber bundles NF collected by the second collecting roller 120b.

As shown in FIG. 3, the first spreader roller 122a and the second spreader roller 122b are preferably serrated rollers. In this case, each of the side surface of the first spreader roller 122a and the side surface of the second spreader roller 122b is formed of an uneven surface having an uneven portion 123. However, it is not essential that each of the side surface of the first spreader roller 122a and the side surface of the second spreader roller 122b has the uneven portion 123. The first spreader roller 122a and the second spreader roller 122b may be smooth rollers having no unevenness on the side surfaces and having a circular cross section in the diametrical direction.

In FIG. 3, the first consolidating roller 124a and the second consolidating roller 124b are also shown as the serrated rollers. However, the first consolidating roller 124a and the second consolidating roller 124b may be smooth rollers defined as described above.

As shown in FIG. 3, the upstream guide roller 126, the detection roller 130, and the downstream guide roller 132 are preferably smooth rollers. However, the upstream guide roller 126, the detection roller 130, and the downstream guide roller 132 may be the serrated rollers defined as described above.

The detection roller 130 is an embodiment of the tension detector 128. The belt-shaped bundle FT stretched from the upstream guide roller 126 to the downstream guide roller 132 contacts a side surface of the detection roller 130. The detection roller 130 measures the tension of the belt-shaped bundle FT. The measured value of the tension is displayed on, for example, a display (not shown). The tension detector 128 is not limited to the detection roller 130. The tension detector 128 may be a well-known online tension sensor incorporated in a production line.

The fiber feeding head 110 includes a first damper mechanism 140a (damper mechanism) and a second damper mechanism 140b (another damper mechanism). The first damper mechanism 140a and the second damper mechanism 140b are paired. In the above-described configuration, the first spreader roller 122a is supported by the base 112 via the first damper mechanism 140a, and the second spreader roller 122b is supported by the base 112 via the second damper mechanism 140b. This will be described in detail below.

In the illustrated embodiment, the first damper mechanism 140a includes a first elastically deformable part 142a and a first arm member 144a. Alternatively, the first damper mechanism 140a may be a spring.

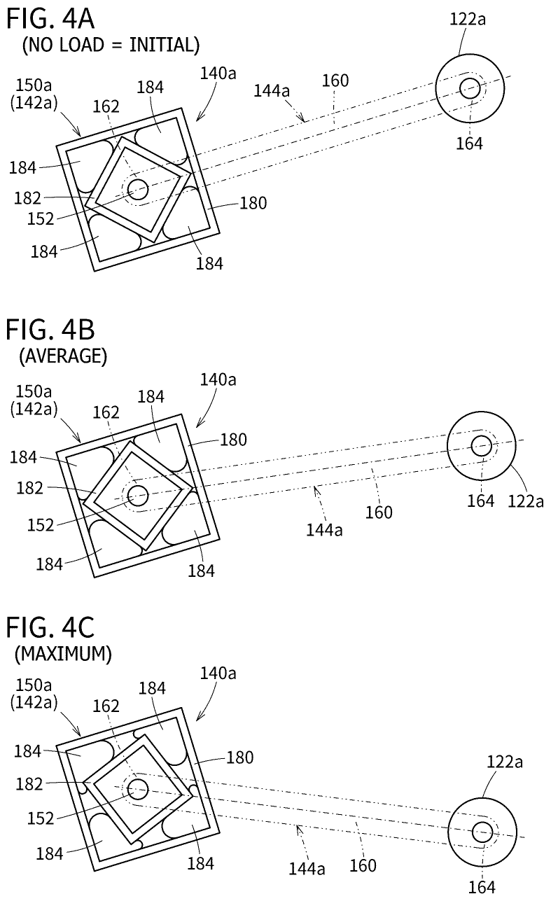

An example of the first elastically deformable part 142a is a first elastic bearing 150a having an insertion hole 152. As shown in FIG. 4A, the first elastic bearing 150a includes, for example, an outer sleeve 180, an inner sleeve 182 disposed in the hollow interior of the outer sleeve 180, and a plurality of rubbers 184 inserted into a clearance between the inner surface of the outer sleeve 180 and the outer surface of the inner sleeve 182. In this case, the insertion hole 152 is provided in the inner sleeve 182. The first elastic bearing 150a is not limited to the bearing shown in FIG. 4A, and the first elastically deformable part 142a is not limited to the first elastic bearing 150a.

The first elastic bearing 150a is sandwiched between the base 112 and a bracket 154. The bracket 154 is connected to the base 112 via a bolt or the like, so that the first elastic bearing 150a is held by the base 112.

The first arm member 144a has a pair of arm pieces 160. One end of each arm piece 160 in the longitudinal direction is a connected end 162 and the other end of each arm piece 160 in the longitudinal direction is a support end 164. Each arm piece 160 has a through hole 166 at the connected end 162. Each through hole 166 is overlapped with the insertion hole 152. Further, a pivot shaft 168 is passed through the through holes 166 and the insertion hole 152. The first arm member 144a is integral with the pivot shaft 168 and is rotationally movable with respect to the base 112. That is, the first arm member 144a does not move relative to the pivot shaft 168.

Each arm piece 160 has a support hole 170 at the support end 164. A first rotation shaft 172a of the first spreader roller 122a is inserted through each of the support holes 170. Thus, the first spreader roller 122a is supported by the base 112 via the first elastic bearing 150a and the first arm member 144a. Therefore, when the tension of the first fiber bundle F1 acts on the first spreader roller 122a, the first elastic bearing 150a is elastically deformed and the first arm member 144a is rotationally moved, so that the first spreader roller 122a is shifted relative to the base 112. The first spreader roller 122a is rotatable relative to the first arm member 144a about the first rotation shaft 172a.

The second damper mechanism 140b is configured similarly to the first damper mechanism 140a. That is, the second damper mechanism 140b includes, for example, a second elastically deformable part 142b and a second arm member 144b. Therefore, in FIG. 3, the same constituent elements of the second elastically deformable part 142b as those of the first elastically deformable part 142a are designated by the same reference numerals. Similarly, in the second arm member 144b, the same constituent elements as those of the first arm member 144a are designated by the same reference numerals. The second damper mechanism 140b may be a spring.

When the tension of the second fiber bundle F2 acts on the second spreader roller 122b, the second elastic bearing 150b is elastically deformed and the second arm member 144b is rotationally moved, so that the second spreader roller 122b is shifted relative to the base 112. The second spreader roller 122b is rotatable relative to the second arm member 144b about a second rotation shaft 172b.

In the direction intersecting the moving direction of the fiber bundle F1, the first damper mechanism 140a and the second damper mechanism 140b are provided outward of the first collecting roller 120a and the second collecting roller 120b. In the illustrated example, the first collecting roller 120a and the second collecting roller 120b are located between the connected end 162 of the first arm member 144a in the first damper mechanism 140a and the connected end 162 of the second arm member 144b in the second damper mechanism 140b.

Next, the operation of the FW device 100 when winding the belt-shaped bundle FT (the merged body of the first fiber bundle F1 and the second fiber bundle F2) around the liner 20 will be described.

Some of the thin fiber bundles NF supplied from some of the plurality of bobbins 102 shown in FIG. 1 are supplied to the first collecting roller 120a of the fiber feeding head 110. The plurality of thin fiber bundles NF are collected by the first collecting roller 120a, thereby forming the first fiber bundle F1.

Next, the first fiber bundle F1 is spread by the first spreader roller 122a shown in FIG. 3. The direction in which the first fiber bundle F1 spreads is the widthwise direction perpendicular to the moving direction of the first fiber bundle F1. That is, the first fiber bundle F1 is appropriately widened by the first spreader roller 122a.

On the other hand, some other thin fiber bundles NF supplied from some other of the plurality of bobbins 102 shown in FIG. 1 are supplied to the second collecting roller 120b of the fiber feeding head 110. The other of the plurality of thin fiber bundles NF are collected by the second collecting roller 120b, thereby forming the second fiber bundle F2.

The first fiber bundle F1 widened by the first spreader roller 122a is conveyed toward the first consolidating roller 124a. The second fiber bundle F2 widened by the second spreader roller 122b is conveyed toward the second consolidating roller 124b. The first fiber bundle F1 and the second fiber bundle F2 are collected downstream of the first consolidating roller 124a and the second consolidating roller 124b, and the belt-shaped bundle FT is formed. The belt-shaped bundle FT is supplied to the liner 20 via the upstream guide roller 126, the detection roller 130, and the downstream guide roller 132. The liner 20 is started to be rotated in advance.

The delivery head 104 is linearly moved along the axial direction of the liner 20, and the fiber feeding head 110 is appropriately rotated with respect to the delivery head 104, whereby the belt-shaped bundle FT is wound around the outer peripheral surface of the liner 20. As shown in FIG. 2, when the belt-shaped bundle FT is wound around the liner 20 by helical winding, the helical layer 42 is formed on the first dome portion 22, the cylindrical portion 24, and the second dome portion 26. When the belt-shaped bundle FT is wound around the liner 20 by hoop winding, the hoop layer 44 is formed on the cylindrical portion 24. In this manner, the reinforcing layer 40 is formed on the outer peripheral surface of the liner 20.

The detection roller 130 shown in FIG. 3 obtains a measurement value of the tension of the belt-shaped bundle FT. The measurement value is displayed on a display. An operator can determine whether or not the reinforcing layer 40 having sufficient tension is formed by monitoring the measurement value. A warning sound may be issued when the tension is out of the specified range.

As shown in FIG. 2, when the delivery head 104 moves from the cylindrical portion 24 to the first dome portion 22 in the case of forming the helical layer 42 on the liner 20, the delivery head 104 is braked, and thus the delivery head 104 decelerates. As a result, the fiber feeding speed of the thin fiber bundles NF from the bobbins 102 becomes higher than the winding speed of the belt-shaped bundle FT around the liner 20, and thus the belt-shaped bundle FT is loosened and the tension becomes small. On the other hand, when the delivery head 104 having changed the moving direction moves from the first dome portion 22 to the cylindrical portion 24, the delivery head 104 is accelerated. As a result, the fiber feeding speed of the thin fiber bundles NF from the bobbins 102 becomes lower than the winding speed of the belt-shaped bundle FT around the liner 20, and thus the belt-shaped bundle FT is tensed and the tension thereof increases.

Similarly, when the delivery head 104 moves from the cylindrical portion 24 to the second dome portion 26, the tension of the belt-shaped bundle FT decreases. When the delivery head 104 that has changed the moving direction moves from the second dome portion 26 to the cylindrical portion 24, the tension of the belt-shaped bundle FT increases. When the belt-shaped bundle FT is wound around the cylindrical portion 24, the fiber feeding speed of the thin fiber bundles NF and the winding speed of the belt-shaped bundle FT are substantially balanced, and the tension becomes an average magnitude (average tension).

The first damper mechanism 140a and the second damper mechanism 140b suppress such variation in tension. To be specific, as shown in FIG. 4A, in a no-load state where the tension of the first fiber bundle F1 does not act on the first spreader roller 122a, the first arm member 144a does not rotationally move and maintains the initial inclined position. The first spreader roller 122a remains in its unmoved initial position.

In contrast, in a case where the hooping layer 44 is formed on the cylindrical portion 24, a tension of the average magnitude (average tension) acts on the first spreader roller 122a from the first fiber bundle F1. The first spreader roller 122a is pulled by the first fiber bundle F1 due to the tension. Therefore, the first arm member 144a is also pulled by the first fiber bundle F1.

When the first spreader roller 122a is pulled by the first fiber bundle F1 in this manner, the first elastic bearing 150a constituting the first elastically deformable part 142a is elastically deformed. For example, some of the plurality of rubbers 184 shown in FIGS. 4A and 4B are compressed, while some of the plurality of rubbers 184 are expanded. As shown in FIG. 4B, the first arm member 144a is rotationally moved in a direction pulled by the first fiber bundle F1 in accordance with such elastic deformation. That is, the first arm member 144a is integral with the pivot shaft 168 and rotationally moved in a direction toward the second arm member 144b. As a result, the first spreader roller 122a moves relative to the base 112. The first arm member 144a reaches an average inclined position, and the first spreader roller 122a reaches an average displacement position. That is, the first spreader roller 122a is shifted in a direction that shortens the path length of the first fiber bundle F1.

For example, when the delivery head 104 (see FIGS. 1 and 2) moves from the first dome portion 22 to the cylindrical portion 24, the tension of the belt-shaped bundle FT increases. In this case, as shown in FIG. 4C, elastic deformation of the first elastic bearing 150a becomes greater. With this elastic deformation, the first arm member 144a can be further rotationally moved. The first arm member 144a is further rotationally moved toward the second arm member 144b. As the first arm member 144a reaches the maximum inclination position, the first spreader roller 122a reaches the maximum shift position. In this case, the first arm member 144a is integral with the pivot shaft 168 and the first spreader roller 122a is shifted in the direction that shortens the path length of the first fiber bundle F1.

As described above, as the tension of the first fiber bundle F1 applied to the liner 20 increases, the first spreader roller 122a is shifted in the direction that shortens the path length of the first fiber bundle F1 by the shift amount corresponding to the magnitude of the tension. In this manner, the tension of the first fiber bundle F1 is absorbed. Therefore, the tension of the first fiber bundle F1 is prevented from becoming excessively large.

When the delivery head 104 moves from the cylindrical portion 24 to the second dome portion 26, the tension of the belt-shaped bundle FT decreases. In this case, the first elastic bearing 150a is elastically deformed to restore its original shape. With this elastic deformation, the first arm member 144a is rotationally moved so as to reach, for example, a position between the average inclination position and the initial inclination position. Therefore, the first spreader roller 122a is shifted in a direction that increases the path length of the first fiber bundle F1.

As described above, as the tension of the first fiber bundle F1 applied to the liner 20 decreases, the first spreader roller 122a is shifted in the direction to increase the path length of the first fiber bundle F1. This prevents the first fiber bundle F1 from being loosened.

The same applies to the second fiber bundle F2 conveyed through the second conveyance path 116. That is, the second arm member 144b is integral with the pivot shaft 168 and is rotationally moved in a direction toward the first arm member 144a. Therefore, the belt-shaped bundle FT, which is the merged body of the first fiber bundle F1 and the second fiber bundle F2, can be firmly wound around the liner 20. Therefore, even when the number of times of winding of the belt-shaped bundle FT is small, sufficient strength can be imparted to the liner 20. This makes it possible to reduce the weight of the high-pressure tank as a product. In addition, the breaking strength of the high-pressure tank can be improved.

The present embodiment exhibits the following advantageous effects.

As shown in FIGS. 1 and 3, the fiber feeding head 110 of the FW device 100 includes the first spreader roller 122a and the first damper mechanism 140a, and the second spreader roller 122b and the second damper mechanism 140b. The first damper mechanism 140a and the second damper mechanism 140b support the first spreader roller 122a and the second spreader roller 122b, respectively, and suppress variation in the tensions of the first fiber bundle F1 and the second fiber bundle F2 supplied to the liner 20, which is the workpiece 10.

To be specific, as understood from FIGS. 4A to 4C, when the tensions of the first fiber bundle F1 and the second fiber bundle F2 increase, the first damper mechanism 140a and the second damper mechanism 140b move the first spreader roller 122a and the second spreader roller 122b in directions to decrease the path length of the first fiber bundle F1 and the path length of the second fiber bundle F2, respectively. In this manner, the tension of the first fiber bundle F1 and the tension of the second fiber bundle F2 are absorbed. On the other hand, as the tensions of the first fiber bundle F1 and the second fiber bundle F2 decrease, the first damper mechanism 140a and the second damper mechanism 140b move the first spreader roller 122a and the second spreader roller 122b in the direction to increase the path length of the first fiber bundle F1 and the path length of the second fiber bundle F2, respectively. This prevents the first fiber bundle F1 and the second fiber bundle F2 from being loosened.

Therefore, as shown in FIG. 2, the belt-shaped bundle FT, which is the merged body of the first fiber bundle F1 and the second fiber bundle F2, can be firmly wound around the liner 20. Therefore, even when the number of times of winding of the belt-shaped bundle FT is small, sufficient strength is imparted to the liner 20. Therefore, when the product is a high-pressure tank, the weight of the high-pressure tank can be reduced. In addition, the breaking strength of the high-pressure tank can be improved.

As shown in FIG. 3, the first damper mechanism 140a and the second damper mechanism 140b respectively include a first arm member 144a and a second arm member 144b supported by the first elastically deformable part 142a and the second elastically deformable part 142b. The first spreader roller 122a and the second spreader roller 122b are supported by the first arm member 144a and the second arm member 144b, respectively.

According to this configuration, the first arm member 144a and the second arm member 144b are respectively moved rotationally in accordance with the elastic deformation of the first elastically deformable part 142a and the second elastically deformable part 142b. With this rotational movement, the first spreader roller 122a and the second spreader roller 122b can be easily shifted.

The first elastically deformable part 142a is a first elastic bearing 150a that supports the first arm member 144a. Since the first arm member 144a is easily moved rotationally due to the elastic deformation of the first elastic bearing 150a, the first spreader roller 122a can be easily shifted. Similarly, since the second elastically deformable part 142b is the second elastic bearing 150b that supports the second arm member 144b, the second arm member 144b can be easily moved rotationally, and the second spreader roller 122b can be easily shifted.

Further, the first spreader roller 122a is lighter in weight compared to the case where the first spreader roller 122a is a smooth roller. As a result, the inertia force of the first spreader roller 122a is reduced, and the damping capability of the first damper mechanism 140a is increased. Therefore, the variation in tension of the first fiber bundle F1 is reduced. The same applies to the second spreader roller 122b.

The fiber feeding head 110 includes the downstream guide roller 132 provided downstream of the first spreader roller 122a and the second spreader roller 122b in the moving direction of the first fiber bundle F1 and the second fiber bundle F2. The downstream guide roller 132 is a smooth roller.

A contact resistance of the side surface of the smooth roller with respect to the belt-shaped bundle FT is smaller than that of the serrated roller. Therefore, the belt-shaped bundle FT is less likely to slip toward the liner 20. Therefore, the belt-shaped bundle FT can be reliably fed from the downstream guide roller 132 toward the liner 20.

The fiber feeding head 110 includes the tension detector 128 provided downstream of the first spreader roller 122a and the second spreader roller 122b in the moving direction of the first fiber bundle F1 and the second fiber bundle F2. The tension detector 128 detects the tension of the belt-shaped bundle FT.

As described above, the belt-shaped bundle FT is formed from the first fiber bundle F1 and the second fiber bundle F2 that have passed through the first spreader roller 122a and the second spreader roller 122b, respectively, and then fed toward the liner 20. The tension detector 128 can monitor whether or not the tension of the belt-shaped bundle FT wound around the liner 20 is appropriate.

The tension detector 128 is the detection roller 130. In this case, the detection roller 130 can be incorporated in the third conveyance path 118, and the belt-shaped bundle FT can be wound around the side surface of the detection roller 130. Therefore, the tension of the belt-shaped bundle FT wound around the liner 20 can be easily detected.

In the fiber feeding head 110, the first spreader roller 122a and the second spreader roller 122b form a pair, and the first damper mechanism 140a and the second damper mechanism 140b form a pair. The FW device 100 collects the first fiber bundle F1 having passed through the first spreader roller 122a and the second fiber bundle F2 having passed through the second spreader roller 122b, and supplies the collected fiber bundles to the liner 20 as the belt-shaped bundle FT.

The belt-shaped bundle FT is wider than the first fiber bundle F1 or the second fiber bundle F2, for example. Therefore, in a case where the belt-shaped bundle FT is wound once around the liner 20, the area of the liner 20 covered by one winding is wider than that in a case where only the first fiber bundle F1 or only the second fiber bundle F2 is wound once around the liner 20. Therefore, the reinforcing layer 40 can be efficiently formed.

In relation to the above-described embodiment, the following supplementary notes are further disclosed.

### Supplementary Note 1

The filament winding device (100) according to the present disclosure is configured to wind around the workpiece (10) the fiber bundle (F1) formed of the plurality of fibers, and includes the delivery head (104) configured to move relative to the workpiece, and the fiber feeding head (110), with which the delivery head is provided, the fiber feeding head being rotatable relative to the delivery head, wherein the fiber feeding head includes: the spreader roller (122a) that has the side surface around which the fiber bundle is wound, the spreader roller being configured to widen the fiber bundle on the side surface; and the damper mechanism (140a) supporting the spreader roller, the damper mechanism being configured to suppress variation in tension of the fiber bundle supplied to the workpiece, the damper mechanism moves the spreader roller in the direction that shortens the path length of the fiber bundle as the tension of the fiber bundle increases, and move the spreader roller in the direction that increases the path length of the fiber bundle as the tension of the fiber bundle decreases.

The spreader roller moves as described above according to the tension of the fiber bundle, and thereby the tension is absorbed when the tension of the fiber bundle increases. On the other hand, when the tension of the fiber bundle is reduced, the fiber bundle is prevented from being loosened. Therefore, the fiber bundle can be wound around the workpiece firmly.

Therefore, even when the number of times of winding of the fiber bundle is small, sufficient strength can be imparted to the workpiece from the fiber bundle. Therefore, the weight of a product obtained by winding the fiber bundle around the workpiece can be reduced. In addition, the breaking strength of the product can be improved.

### Supplementary Note 2

In the filament winding device according to Supplementary Note 1, in the damper mechanism, the base (112) of the fiber feeding head may be provided with an elastically deformable part (142a) that is elastically deformable, and the spreader roller may be shifted in accordance with elastic deformation of the elastically deformable part.

Based on the elastic deformation of the elastically deformable part, the spreader roller is easily shifted. In addition, the spreader roller can easily return to the original position.

### Supplementary Note 3

In the filament winding device according to Supplementary Note 2, the damper mechanism may include the arm member (144a) supported by the elastically deformable part, the spreader roller may be supported by the arm member, and the arm member may be rotationally moved as the elastically deformable part is elastically deformed.

The elastically deformable part is elastically deformed based on the rotational movement of the arm member, and the spreader roller is easily shifted.

### Supplementary Note 4

In the filament winding device according to Supplementary Note 3, the elastically deformable part may be the elastic bearing (150a), and the elastic bearing may support the arm member.

The elastic bearing is elastically deformed, and thereby the arm member can be easily moved rotationally. Therefore, the spreader roller can be easily shifted.

### Supplementary Note 5

In the filament winding device according to any one of Supplementary Notes 1 to 4, the side surface of the spreader roller may be the uneven surface having the uneven portion (123).

In this case, the fiber bundle is prevented from falling off from the spreader roller. Further, the spreader roller is lighter than a case where the spreader roller is a smooth roller. Therefore, the inertial force of the spreader roller is reduced, and the damping capacity of the damper mechanism is increased. Therefore, variation in tension of the fiber bundle is reduced.

### Supplementary Note 6

In the filament winding device according to any one of Supplementary Notes 1 to 5, the fiber feeding head may include the guide roller (132) provided downstream of the spreader roller in a moving direction of the fiber bundle, and the guide roller may be the smooth roller having the circular cross section in the diameter direction and having the smooth side surface.

In this case, the fiber bundle is easily fed toward the workpiece.

### Supplementary Note 7

In the filament winding device according to any one of Supplementary Notes 1 to 6, the fiber feeding head may include the collecting roller (120a) disposed upstream of the spreader roller in the moving direction of the fiber bundle, the collecting roller being configured to collect the plurality of thin fiber bundles (NF) to obtain the fiber bundle.

The collecting roller can merge a plurality of thin fiber bundles to obtain a wide fiber bundle.

### Supplementary Note 8

In the filament winding device according to any one of Supplementary Notes 1 to 7, the fiber feeding head may include the tension detector (128) disposed downstream of the spreader roller in the moving direction of the fiber bundle, the tension detector being configured to detect the tension of the fiber bundle.

By monitoring with the tension detector, an operator can determine whether or not the tension of the fiber bundle fed to the workpiece is appropriate.

### Supplementary Note 9

In the filament winding device according to Supplementary Note 8, the tension detector may be the detection roller (130) having the side surface on which the fiber bundle is wound.

In this case, the tension of the fiber bundle can be detected while continuing the supply of the fiber bundle to the workpiece.

### Supplementary Note 10

In the filament winding device according to any one of Supplementary Notes 1 to 9, the fiber feeding head may include the other spreader roller (122b) paired with the spreader roller and the other damper mechanism (140b) paired with the damper mechanism, the other fiber bundle (F2) may be wound around a side surface of the another spreader roller, and the fiber bundle having passed through the spreader roller and the another fiber bundle having passed through the another spreader roller may be collected and supplied to the workpiece.

This enables the fiber bundle to be efficiently wound around the workpiece.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A filament winding device configured to wind around a workpiece a fiber bundle formed of a plurality of fibers, the filament winding device comprising:
a delivery head configured to move relative to the workpiece; and
a fiber feeding head, with which the delivery head is provided, the fiber feeding head being rotatable relative to the delivery head,
wherein the fiber feeding head includes:
a spreader roller that has a side surface around which the fiber bundle is wound, the spreader roller being configured to widen the fiber bundle on the side surface; and
a damper mechanism supporting the spreader roller, the damper mechanism being configured to suppress variation in tension of the fiber bundle supplied to the workpiece,
wherein the damper mechanism moves the spreader roller in a direction that shortens a fiber bundle path length as a tension of the fiber bundle increases, and moves the spreader roller in a direction that increases the fiber bundle path length as the tension of the fiber bundle decreases.

2. The filament winding device according to claim 1, wherein in the damper mechanism, a base of the fiber feeding head is provided with an elastically deformable part that is elastically deformable, and
the spreader roller is shifted in accordance with elastic deformation of the elastically deformable part.

3. The filament winding device according to claim 1, wherein the side surface of the spreader roller is an uneven surface having an uneven portion.

4. The filament winding device according to claim 1, wherein the fiber feeding head includes a guide roller provided downstream of the spreader roller in a moving direction of the fiber bundle, and the guide roller is a smooth roller having a circular cross section in a diameter direction and having a smooth side surface.

5. The filament winding device according to claim 1, wherein the fiber feeding head includes a collecting roller disposed upstream of the spreader roller in a moving direction of the fiber bundle, the collecting roller being configured to collect a plurality of thin fiber bundles to obtain the fiber bundle.

6. The filament winding device according to claim 1, wherein the fiber feeding head includes a tension detector disposed downstream of the spreader roller in a moving direction of the fiber bundle, the tension detector being configured to detect a tension of the fiber bundle.

7. The filament winding device according to claim 6, wherein the tension detector is a detection roller having a side surface on which the fiber bundle is wound.

8. The filament winding device according to claim 2, wherein the damper mechanism includes an arm member supported by the elastically deformable part, and the spreader roller is supported by the arm member, and
the arm member is rotationally moved as the elastically deformable part is elastically deformed.

9. The filament winding device according to claim 8, wherein the elastically deformable part is an elastic bearing, and the elastic bearing supports the arm member.

10. The filament winding device according to claim 1, wherein the fiber feeding head includes another spreader roller paired with the spreader roller and another damper mechanism paired with the damper mechanism, and another fiber bundle is wound around a side surface of the another spreader roller, and
the fiber bundle having passed through the spreader roller and the another fiber bundle having passed through the another spreader roller are collected and supplied to the workpiece.
